(19) United States
(12) Patent Application Publication
(10) Pub. No.: US 2006/0218814 A1
(43) Pub. Date: Oct. 5, 2006

(54) Method and apparatus for drying a fibrous material

(75) Inventor: Torsten Koch, Bad Oldesloe (DE)

Correspondence Address: VENABLE LLP, P.O. BOX 34385, WASHINGTON, DC, 20045-9998, US

(73) Assignee: Hauni Maschinenbau Ag, Hamburg (DE)

(21) Appl. No.: 11/392,552

(22) Filed: Mar. 30, 2006

(30) Foreign Application Priority Data
Apr. 1, 2005 (DE) 10 2005 015 781.5

(51) Int. Cl. F26B 3/08; F26B 19/00

(52) U.S. Cl. 34/360; 34/553

(57) ABSTRACT

The application concerns a method for drying a fibrous material by means of a process gas stream flowing through a pipe, including heating the process gas flowing through the pipe by means of a heater with controllable heating power, and conducting a portion of the process gas stream through a bypass pipe bypassing the heater, wherein the ratio of mass flows of process gas flowing through the heater and through the bypass pipe is adjustable, and is distinguished by the fact that the heating power of the heater is controlled according to the set ratio of mass flows of process gas through the heater and through the bypass pipe. The application further concerns a corresponding drying apparatus.

### CROSS-REFERENCE TO RELATED APPLICATION

This application claims the priority of German Patent Application No. 10 2005 015 781.5 filed Apr. 1, 2005, the subject matter of which is incorporated herein by reference. The disclosure of all U.S. and foreign patents and patent applications mentioned below are also incorporated herein by reference.

### BACKGROUND OF THE INVENTION

The invention concerns a method and an apparatus for drying a fibrous material according to the preamble of claims 1 and 12.

Such an apparatus is known from DE 33 05 670 C2, which comprises a regulating bypass and a second parallel standby bypass. The mass flow of process gas flowing through the regulating bypass is regulated as a function of the temperature of the load. The fuel and the combustion air for the burner are regulated as a function of the temperature of the flue gases produced by the burner. Ballast air for the burner is regulated as a function of the temperature of the process gas stream behind the heat exchanger. A reduction of the mass flow of process gas flowing through the regulating bypass leads to an increase in the wall temperature in the heat exchanger and therefore, on account of the high inertia of the heat exchanger, a significant delay in regulation of the temperature of the process gas stream, and hence a reduction of efficiency of the drying apparatus.

### SUMMARY OF THE INVENTION

It is the object of the present invention to provide a drying method and a drying apparatus which allow quick regulation and efficient operation.

The invention achieves this object with the features of claims 1 and 12. Control of the heating power of the heater according to the invention permits adaptation in particular to the variable mass flow of process gas through the heater. The invention realizes that variations in the mass flow of process gas through the heater can lengthen the regulation times in relation to the process gas temperature, and that this can be counteracted by control of the heating power of the burner.

Control does not necessarily mean unregulated control, but can also be regulation. Control is therefore to be understood within the scope of this application as control and/or regulation. Control of the heating power can take place differently, for example by control of the combustion air supply, the fuel supply and/or ballast air.

Particularly useful is application of the invention to a heater with indirect heating, in particular by means of a heat exchanger which reacts particularly inertly on account of the high mass.

In a preferred embodiment, the setpoint for a preferred regulation of the heating power of the heater as a function of the temperature of the process gas leaving the heater is varied depending on the set mass flow of process gas through the heater.

### BRIEF DESCRIPTION OF THE DRAWINGS

Further advantageous characteristics are apparent from the subsidiary claims and the following description of advantageous embodiments with reference to the attached drawing. It shows:

FIG. 1: a schematic view of a drying apparatus for a tobacco product.

### DETAILED DESCRIPTION OF THE INVENTION

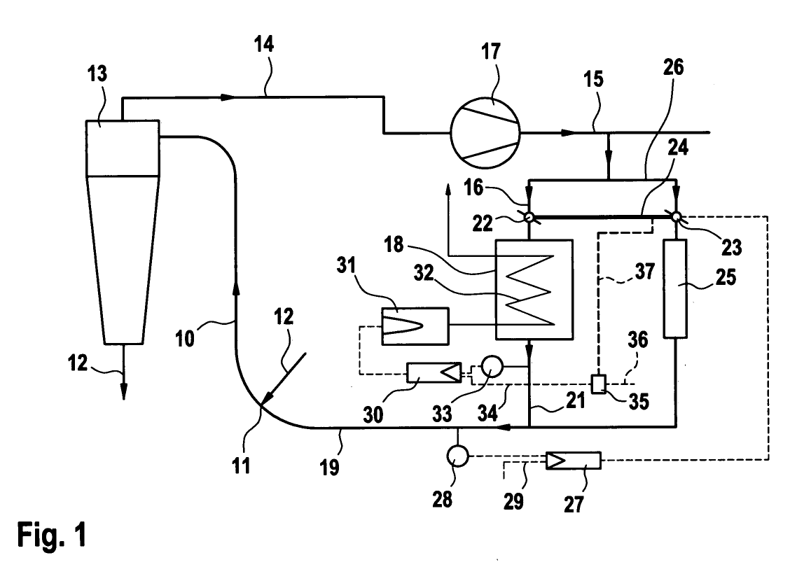

The drying apparatus shown in FIG. 1 includes a tubular flash dryer 10 through which hot process gas flows with or without vapour fraction, in particular hot air or hot steam (superheated steam) with a temperature of between 130° C. and 500° C. The flash dryer 10 is part of a pipe circuit through which the process gas flows in the arrow direction. The flash dryer 10 comprises a product inlet 11 for the tobacco 12 to be dried. The tobacco 12 is transported by the process gas stream and, in the process, dried in the flash dryer 10. The dried tobacco is separated by means of the separator 13 from the hot gas which is delivered via pipes 14 to 16 via a compressor 17 to a heat exchanger 18. By means of the heat exchanger 18, the process gas is heated to the desired drying temperature in order to recycle the heat extracted by the drying process. For this purpose heat is delivered to the heat exchanger 18 by means of a combustion gas stream 32 produced by a burner 31. The heated process gas is passed via the supply pipe 19 to the flash dryer 10.

Parallel to the heat exchanger 18 is provided a bypass pipe 26 with a flow resistance 25, for example, a throttle, for a portion of the process gas stream. The proportion of the process gas stream flowing through the heat exchanger 18 or bypass pipe 26 is adjustable by means of a valve 22 arranged in the hot pipe 16 or a valve 23 arranged in the bypass pipe 26. The valves 22, 23 are each adjustable between a nearly closed position (for example, 10% mass flow of gas) and a nearly fully open position (for example, 90% mass flow of gas). The range of adjustment can also be between 20% and 80% of the total mass flow of gas. The valves 22 and 23 can be connected to each other, for example, mechanically with a connecting means 24, in such a way that opening of one valve automatically causes closing of the other valve and vice versa (double valve). However, the invention is not by any means restricted to this. The ratio of the mass flows of process gas can also be adjustable only by means of a valve 22 arranged in the hot pipe 16, only by means of a valve 23 arranged in the bypass pipe 26, by means of two independently adjustable valves 22, 23 or otherwise.

By adjustment of the valves 22, 23, different mixture ratios can be set between the relatively cool return process gas flowing through the return pipe 15, 16 and the hot process gas heated by the heat exchanger 18. If, for instance, the process gas temperature in the return pipe 14, 15 is 140° C. and the temperature of the hot process gas in pipe section 21, which is heated by the heat exchanger 18, is 260° C., then by varying the position of the valves 22, 23 the operating temperature in the supply pipe 19 can in principle be adjusted within a range of between 152° C. (10% mass flow of gas through the heat exchanger 18 and 90% mass flow of gas through the bypass pipe 26) and 248° C. (90% mass flow of gas through the heat exchanger 18 and 10% mass flow of gas through the bypass pipe 26).

The position of the valves 22, 23 is regulated by means of a first regulating member 27 in such a way that the temperature in the supply pipe 19 measured with a first temperature sensor 28 has the setpoint operating temperature set via the setpoint input 29. As temperature changes rapidly by mixing of the heated process gas stream and the cooled process gas stream, this first regulating circuit involves rapid temperature regulation.

If now, for example, the throughflow rate through the heat exchanger 18 is lowered by corresponding adjustment of the valves 22, 23 in order to lower the operating temperature of the process gas in the supply pipe 19, the wall temperature of the pipes in the flow heater and hence also the temperature of the process gas leaving the heat exchanger 18 rises. This effect runs counter to the desired lowering of the operating temperature of the process gas and so impairs regulation of the operating temperature of the process gas by means of the first regulating circuit described. Preferably, therefore, a second regulating circuit with a second regulating device 30 is provided, with which the heating power of the burner 31 is regulated so that the temperature in the pipe 21 behind the heat exchanger 18, which is measured with a second temperature sensor 33, is kept constant, namely at the setpoint temperature set via the corresponding setpoint input 34, for example, 260° C. In the above example in which the throughflow rate through the heat exchanger 18 is lowered by corresponding adjustment of the valves 22, 23, regulation of the second regulating circuit leads to relatively rapid lowering of the burner power. Thus the temperature variations in the heat exchanger, in particular the wall temperature of the heat exchanger pipes, can be kept almost constant, so that the corresponding regulation in the second regulating circuit reacts rapidly.

To extend the regulating range and to reduce the regulation time in the second regulating circuit, the setpoint for the second regulating member 30 is varied according to the position of the valves 22, 23. In the example of FIG. 1 this is done by means of a separate adding member 35 which adds an original setpoint signal 36 to a signal 37 dependent on the position of the valves 22, 23 (setpoint superimposing).

The manner of operation of setpoint superimposing will be illustrated by an example. Here the process gas temperature in the return pipe 14, 15 is 140° C. and the temperature of the hot process gas in pipe section 21, which is heated by the heat exchanger 18, is first regulated by means of the second regulating circuit to a setpoint of 2600C. The position of the valves 22, 23 is adjusted in such a way that 50% of the mass flow of process gas flows through the heat exchanger 18 and 50% through the bypass pipe 26. The operating temperature of the process gas in the supply pipe 19 is therefore first regulated to 200° C. If now a reduction of the operating temperature in the supply pipe 19 to below 200° C. is to be effected, as described above the throughflow rate through the heat exchanger 18 is lowered by corresponding adjustment of the valves 22, 23 by means of the first regulating circuit. If now the mass flow of process gas through the heat exchanger 18 drops below a certain value, preferably below 30% of the total mass flow of process gas, further preferably already below 37% of the total mass flow of process gas, the original setpoint of 260° C. for the second regulating member 30 is lowered by superimposing of a corresponding signal 37, whereby the heating power of the burner 31 is lowered immediately. As a result, therefore, the required reduction of the heating power of the burner 31 will take place very rapidly after adjustment of the mass flow of process gas through the heat exchanger 18, in particular considerably more rapidly than by the second regulating circuit on its own. A change of temperature of the walls of the heat exchanger is thus prevented in advance. In other words, it is the aim of setpoint superimposing to keep the wall temperature on the pipes in the heat exchanger as constant as possible. In general, the regulation time can be considerably shortened by this means.

The reduction of the heating power of the burner 31 then acts towards a reduction of the operating temperature of the process gas in the supply pipe 19, which, on account of the first regulating circuit, causes an adjustment of the valves 22, 23 in order to increase the mass flow of process gas through the heat exchanger 18 again. On account of the counteracting operation of the first and second regulating circuits, the valves are set back from their extreme positions again towards a position in an optimum medium operating range, for example, corresponding to ±20%, preferably ±13% of the total mass flow of process mass through the heat exchanger 18, around an average value of 50%, for example. In this operating range the flow conditions in the heat exchanger 18 are approximately constant and allow reliable and efficient regulation. Further, on account of the counteract operation of the first and second regulating circuits, a shortening of the regulation time can be achieved.

Preferably, the lower the mass flow of process gas flowing through the heat exchanger 18 is in proportion to the total mass flow of process gas, the more the setpoint is lowered. This can be done linearly, for example, the invention by no means being restricted to this. Particularly preferred is a setpoint superimposing function which is selected or determined empirically with a view to maximum-speed counterregulation to the first regulator 27, 28.

What has been stated above can be transferred correspondingly to the case of an increase in operating temperature of the process gas in the supply pipe 19.

Other rearrangements of the described setpoint superimposing are possible. For example, a programmable control device which controls the valves 22, 23 and in which the current position of the valves 22, 23 is stored can generate a corresponding setpoint signal and send it to the setpoint input 34 of the second regulating member 30, without a separate adding member 35 being required for this.

The invention has been described in detail with respect to preferred embodiments, and it will now be apparent from the foregoing to those skilled in the art, that changes and modifications may be made without departing from the invention in its broader aspects, and the invention, therefore, as defined in the appended claims, is intended to cover all such changes and modifications that fall within the true spirit of the invention.

What is claimed is:

1. Method for drying a fibrous material by means of a process gas stream flowing through a pipe, including heating the process gas flowing through the pipe by means of a heater with controllable heating power, and conducting a portion of the process gas stream through a bypass pipe bypassing the heater, wherein the ratio of mass flows of process gas flowing through the heater and through the bypass pipe being adjustable, characterised in that the heating power of the heater is controlled according to the set ratio of mass flows of process gas through the heater and through the bypass pipe.

2. Method according to claim 1, characterised in that the heating power of the heater is regulated as a function of the temperature of the process gas leaving the heater.

3. Method according to claim 2, characterised in that regulation of the heating power of the heater is affected by the set mass flow of process gas through the heater.

4. Method according to claim 2, characterised in that the setpoint for regulation of the heating power of the heater is changed according to the set mass flow of process gas through the heater.

5. Method according to claim 1, characterised in that the heating power of the heater is reduced as a result of a reduction of the mass flow of process gas flowing through the heater.

6. Method according to claim 1, characterised in that the heating power of the heater is increased as a result of an increase of the mass flow of process gas flowing through the heater.

7. Method according to claim 5, characterised in that the lower or higher the mass flow of process gas flowing through the heater, the greater the decrease or increase of heating power of the heater.

8. Method according to claim 1, characterised in that the setpoint superimposing for control of the heating power of the heater sets in when the mass flows of process gas deviate from a mean value by more than 20%, preferably by more than 13%.

9. Method according to claim 1, characterised in that the ratio of mass flows of process gas through the heater and through the bypass pipe is regulated as a function of the temperature of the process gas used for drying.

10. Method according to claim 1, characterised in that the heater includes a heat exchanger arranged in the pipe.

11. Method according to claim 10, characterised in that the heating power of the heater is controlled in such a way that variations of the wall temperature in the heat exchanger remain as small as possible as a result of a variation in the mass flow of process gas flowing through the heater.

12. Apparatus for drying a fibrous material by means of a process gas stream flowing through a pipe, with a heater installed in the pipe for heating the process gas flowing through the pipe, wherein the heating power of the heater being controllable, a bypass pipe bypassing the heater for a portion of the process gas stream, and a controllable device for adjusting the ratio of mass flows of process gas flowing through the heater and through the bypass pipe, characterised in that the apparatus has control means for controlling the heating power of the heater according to the adjusted ratio of mass flows of process gas through the heater and through the bypass pipe.

13. Apparatus according to claim 12, characterised in that a regulating circuit is provided for regulating the heating power of the heater to a constant temperature of the process gas leaving the heater.

14. Apparatus according to claim 13, characterised in that the control means is adapted to affect the regulating circuit.

15. Apparatus according to claim 13, characterised in that the control means is adapted to vary the setpoint of the regulating circuit according to the adjusted mass flow of process gas through the heater.

16. Apparatus according to claim 12, characterised in that the heater has a heat exchanger arranged in the pipe.

17. Apparatus according to claim 12, characterised in that the device for adjusting the ratio of mass flows of process gas flowing through the heater and through the bypass pipe includes at least one adjustable valve.

18. Apparatus according to claim 17, characterised in that control of the heating power of the heater is affected as a function of the position of the valve.

19. Apparatus according to claim 12, characterised in that a regulating circuit is provided for regulating the ratio of mass flows of process gas through the heater and through the bypass pipe as a function of the temperature of the process gas used for drying.
